(19) United States
(12) Patent Application Publication
(10) Pub. No.: US 2026/0302196 A1
(43) Pub. Date: Oct. 1, 2026

(54) ELECTRODE ACTIVE MATERIAL COMPOSITE PARTICLE AND BATTERY

(71) Applicant: TOYOTA JIDOSHA KABUSHIKI KAISHA, Toyota-shi (JP)

(72) Inventor: Kazushige NOMOTO, Sunto-gun (JP)

(73) Assignee: TOYOTA JIDOSHA KABUSHIKI KAISHA, Toyota-shi (JP)

(21) Appl. No.: 19/461,026

(22) Filed: Jan. 27, 2026

(30) Foreign Application Priority Data
Mar. 27, 2025 (JP) 2025-054176

(51) Int. Cl. H01M 4/40; C22C 1/10; C22C 24/00; H01M 4/02

(52) U.S. Cl. CPC H01M 4/405; C22C 1/1026; C22C 24/00; H01M 2004/027

(57) ABSTRACT

The electrode active material composite particle of the present disclosure includes a plurality of electrode active material primary particles. In the electrode active material composite particle of the present disclosure, the electrode active material primary particles include a lithium-silicon alloy in a discharged state. A battery of the present disclosure includes an electrode active material layer, and the electrode active material layer contains the electrode active material composite particle of the present disclosure.

### CROSS-REFERENCE TO RELATED APPLICATION

This application claims priority to Japanese Patent Application No. 2025-054176 filed on Mar. 27, 2025. The disclosure of the above-identified application, including the specification, drawings, and claims, is incorporated by reference herein in its entirety.

### BACKGROUND

### 1. Technical Field

The present disclosure relates to electrode active material composite particles and batteries.

### 2. Description of Related Art

It is known that, in batteries that include silicon as an electrode active material, silicon expands and contracts during charging and discharging. Techniques have been developed that mitigate the impact of such expansion and contraction by providing voids within the electrode active material layer.

For example, Japanese Unexamined Patent Application Publication No. 2019-121557 (JP 2019-121557 A) discloses an anode layer for use in an all-solid-state battery. The anode layer contains an anode active material and a sulfide solid electrolyte. The anode active material is a composite particle that includes a plurality of particles containing Si or Sn and a binder, and the anode active layer has a porosity of 15% or less.

### SUMMARY

Voids within the electrode active material composite particles can mitigate the impact of silicon expansion and contraction during battery charging and discharging. However, there is room for improvement in mitigating the impact of such expansion and contraction in electrode active material composite particles containing silicon.

An object of the present disclosure is to provide an electrode active material composite particle capable of mitigating the impact of silicon expansion and contraction during battery charging and discharging, and a battery that includes such an electrode active material composite particle.

The inventors have found that the following means can address the foregoing issue.

### First Aspect

An electrode active material composite particle including a plurality of electrode active material primary particles, wherein the electrode active material primary particles include a lithium-silicon alloy in a discharged state.

### Second Aspect

The electrode active material composite particle according to the first aspect, wherein the lithium-silicon alloy is represented by a compositional formula LiₓSi, where x is 0.1 or more as detected by spherical aberration-corrected scanning transmission electron microscopy (Cs-STEM-EELS) analysis.

### Third Aspect

The electrode active material composite particle according to the second aspect, wherein x is from 0.1 to 0.5.

### Fourth Aspect

The electrode active material composite particle according to any one of the first to third aspects, wherein the electrode active material primary particles are porous.

### Fifth Aspect

A battery including an electrode active material layer,
wherein the electrode active material layer contains the electrode active material composite particle according to any one of the first to fourth aspects.

The present disclosure can provide an electrode active material composite particle capable of mitigating the impact of silicon expansion and contraction during battery charging and discharging, and a battery that includes such an electrode active material composite particle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic view showing an electrode active material composite particle of the present disclosure before expansion;

FIG. 1B is a schematic view showing the electrode active material composite particle after expansion;

FIG. 2A is a schematic view showing a conventional electrode active material composite particle before expansion;

FIG. 2B is a schematic view showing the conventional electrode active material composite particle after expansion; and

FIG. 3 is a schematic sectional view showing an example of a battery according to the present disclosure.

### DETAILED DESCRIPTION OF EMBODIMENTS

An embodiment of the present disclosure will be described below in detail. The present disclosure is not limited to the embodiment described below, and various modifications may be made within the scope of the present disclosure.

### Electrode Active Material Composite Particle

An electrode active material composite particle of the present disclosure includes a plurality of electrode active material primary particles. In the electrode active material composite particle of the present disclosure, the electrode active material primary particles include a lithium-silicon alloy in the discharged state.

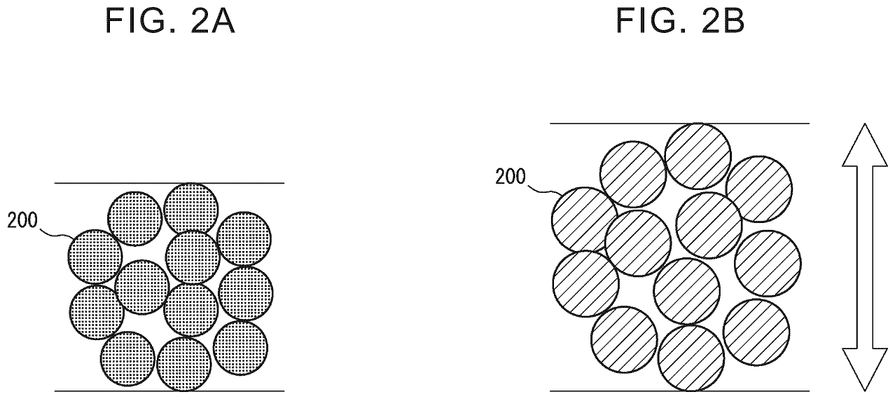

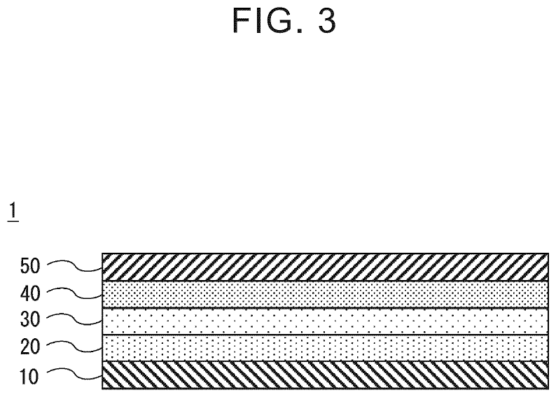

The inventors considered that one cause of insufficient mitigation of the impact of silicon expansion and contraction in batteries including electrode active material composite particles lies in the high Young's modulus of the electrode active material primary particles that make up the composite particle. While not wishing to be bound by any theory, the following is inferred. In a composite particle including electrode active material primary particles 200 having a relatively high Young's modulus, that is, electrode active material primary particles 200 that are not easily deformable, the voids within the composite particle are not effectively used, as illustrated in FIGS. 2A and 2B.

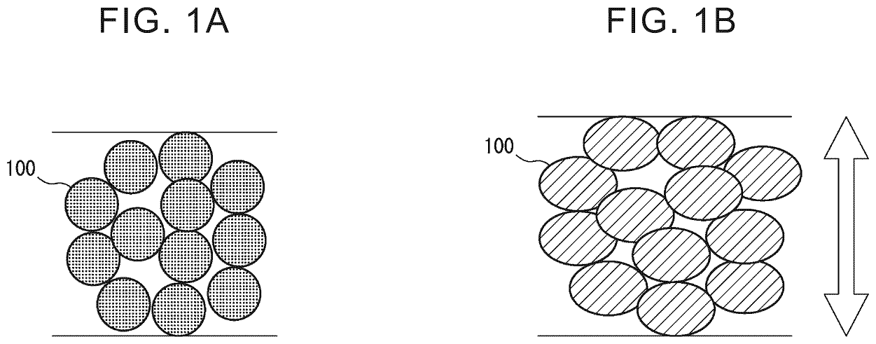

The inventors found that the electrode active material composite particle of the present disclosure can mitigate the impact of silicon expansion and contraction during charging and discharging. While not wishing to be bound by any theory, the following is inferred. In the electrode active material composite particle of the present disclosure, the Young's modulus of the electrode active material primary particles is reduced because silicon is doped with lithium ions. Since the Young's modulus of electrode active material primary particles 100 is relatively low, that is, the electrode active material primary particles 100 are easily deformable, the voids within the composite particle can be utilized effectively, as illustrated in FIGS. 1A and 1B. This is believed to mitigate the impact of silicon expansion and contraction during charging and discharging.

The electrode active material composite particle is a secondary particle formed by agglomeration of a plurality of electrode active material primary particles. The electrode active material composite particle may be a secondary particle formed by granulating the electrode active material primary particles. In the present disclosure, the “electrode active material composite particle” may be simply referred to as “composite particle.”

The “electrode active material” may be either a cathode active material or an anode active material, and may particularly be an anode active material.

Elements that can constitute the electrode active material composite particle of the present disclosure will be described below.

The electrode active material composite particle of the present disclosure includes a plurality of electrode active material primary particles. As will be described later, since the electrode active material primary particles include silicon, they expand and contract during battery charging and discharging.

In the electrode active material composite particle of the present disclosure, the electrode active material primary particles include a lithium-silicon alloy in the discharged state. This enables mitigation of the impact of silicon expansion and contraction during battery charging and discharging.

In the present disclosure, the “discharged state” means a state after constant-current/constant-voltage (CC-CV) discharge to a lower-limit voltage of 0 V at 1/3 C to 1/100 C Cut.

In the electrode active material composite particle of the present disclosure, the lithium-silicon alloy may be represented by the compositional formula LiₓSi, where the value x detected by Cs-STEM-EELS analysis is, for example, 0.1 to 4.0, 0.1 to 3.0, 0.1 to 2.0, 0.1 to 1.0, 0.1 to 0.5, or 0.1 to 0.3. This value may be 0.1 or more, 0.2 or more, or 0.3 or more, and may be 4.0 or less, 3.0 or less, 2.0 or less, 1.0 or less, 0.5 or less, or 0.3 or less. With such values, the impact of silicon expansion and contraction during battery cycling can be effectively mitigated.

The value x can be detected by the method below.

First, a sample is processed by the following method. After an all-solid-state battery including the electrode active material composite particles is disassembled in an argon-atmosphere glove box (oxygen concentration: 10 ppm or less, dew point: −76° C. or less), the anode layer side is fixed to an atmosphere-isolated sample stage, and the sample is introduced into a processing and observation apparatus without exposure to the atmosphere. The all-solid-state battery is in the discharged state, that is, after CC-CV discharge to a lower-limit voltage of 0 V at 1/3 C to 1/100 C Cut. To protect the sample surface during focused ion beam (FIB) processing, the sample is coated with a carbon film in the processing and observation apparatus. Thereafter, by using the FIB micro-sampling method, a small specimen is extracted onto a copper mesh on a vacuum-transfer holder. The extracted specimen is then thinned by cryo-FIB processing at −100° C. to a thickness suitable for transmission electron microscopy (TEM) observation. The equipment that can be used, together with the acceleration voltages and ion source, are as follows.

Equipment: Focused ion/electron beam processing and observation system nanoDUE'T (registered trademark) NB5000, manufactured by Hitachi High-Tech Corporation
Acceleration voltages: 40 kV, 30 kV, 10 kV, 5 kV
Ion source: gallium

The specimen is then observed by the following method. The specimen is mounted on a double-tilt vacuum-transfer holder (648 Double Tilt Vacuum Transfer Holder, manufactured by Gatan, Inc.) inside the glove box, introduced into the transmission electron microscope (TEM) apparatus without exposure to the atmosphere, and observed by Cs-STEM-EELS. The equipment that can be used, together with the acceleration voltage and beam diameter, are as follows.

TEM apparatus: JEM-ARM200F, spherical-aberration-corrected scanning transmission electron microscope, manufactured by JEOL Ltd.
EDX analyzer: JED-2300T SDD, manufactured by JEOL Ltd.
EELS analyzer: GIF Quantum-ER, manufactured by Gatan, Inc.
Acceleration voltage: 200 kV
Beam diameter: approximately φ0.1 nm

The electrode active material primary particles may be porous. That is, the electrode active material primary particles may have multiple pores. As a result, not only the voids within the electrode active material composite particle (described later) but also the pores of the electrode active material primary particles can mitigate the impact of silicon expansion and contraction. The number of pores, pore volume, and pore size of the porous electrode active material primary particles are not particularly limited and may be set as appropriate in consideration of factors such as the degree of silicon expansion and contraction. The pore size may be, for example, on the nanometer order.

The electrode active material primary particles may have a clathrate structure.

The number of electrode active material primary particles included in one electrode active material composite particle is not particularly limited.

The content of the electrode active material primary particles in the electrode active material composite particle is not particularly limited and may be set as appropriate in consideration of factors such as a desired battery capacity.

The d50 of the electrode active material primary particles is not particularly limited. For example, it may be 0.01 μm or more, 0.1 μm or more, 0.5 μm or more, or 1 μm or more, and may be 10 μm or less, 5 μm or less, 3 μm or less, or 1 μm or less.

The d50 particle size of the electrode active material primary particles can be measured using a laser diffraction/scattering particle size distribution analyzer. Pure water can be used as the dispersion medium. The refractive index at the time of measurement may be, for example, 3.5. As the laser diffraction/scattering particle size distribution analyzer, for example, Partica LA-960V2 manufactured by HORIBA, Ltd. can be used.

The electrode active material primary particles can be produced by a method including the following steps:
bringing silicon primary particles into contact with a lithium-containing non-aqueous solution; and
drying and removing the solvent of the lithium-containing non-aqueous solution.

By bringing the silicon primary particles into contact with the lithium-containing non-aqueous solution, lithium ions can be pre-doped into the silicon, thereby forming a lithium-silicon alloy.

The mass ratio between the silicon primary particles and metallic lithium is not particularly limited, and may be set as appropriate in consideration of factors such as a desired value of x in the compositional formula LiₓSi.

The method for bringing the silicon primary particles into contact with the lithium-containing non-aqueous solution is not particularly limited. For example, a method in which the silicon primary particles are added to and mixed with the lithium-containing non-aqueous solution may be employed.

The contact time between the silicon primary particles and the lithium-containing non-aqueous solution is not particularly limited. For example, it may be 10 hours or more, 20 hours or more, 30 hours or more, or 40 hours or more, and may be 100 hours or less, 75 hours or less, 50 hours or less, or 40 hours or less.

The temperature at which the silicon primary particles are brought into contact with the lithium-containing non-aqueous solution is not particularly limited and may be, for example, room temperature.

The composition of the silicon primary particles is not particularly limited as long as silicon is contained. The proportion of silicon among all elements contained in the silicon primary particles may be, for example, 50 mol % or more, 70 mol % or more, 90 mol % or more, 95 mol % or more, or 99 mol % or more. The silicon primary particles may or may not contain elements other than silicon. Examples of elements other than silicon include Li, Sn, Fe, Co, Ni, Ti, Cr, B, and P. The silicon primary particles may also contain silicon oxides.

The silicon primary particles may be amorphous or crystalline. The crystal phase contained in the silicon primary particles is not particularly limited.

By using porous silicon primary particles as the silicon primary particles, porous electrode active material primary particles can be obtained.

The method for preparing the lithium-containing non-aqueous solution is not particularly limited. For example, the solution may be prepared by mixing metallic lithium with a non-aqueous solvent.

Commercially available metallic lithium can be used as the metallic lithium.

The lithium-containing non-aqueous solution may contain an aprotic polar solvent. Since aprotic polar solvents do not ionize and do not react with Li ions, they can suppress a decrease in the amount of Li ions pre-doped into the silicon.

Examples of the aprotic polar solvent include carbonates, esters, ethers, nitriles, sulfones, and lactones. Specific examples include ethylene carbonate (EC), propylene carbonate (PC), diethyl carbonate (DEC), dimethyl carbonate (DMC), ethyl methyl carbonate (EMC), 1,2-dimethoxyethane, 1,2-diethoxyethane, tetrahydrofuran, 2-methyltetrahydrofuran, dioxane, 1,3-dioxolane, diethylene glycol, dimethyl ether, ethylene glycol, acetonitrile, propionitrile, nitromethane, N,N-dimethylformamide, dimethyl sulfoxide, sulfolane, and γ-butyrolactone.

The lithium-containing non-aqueous solution may further contain a solvent other than the aprotic polar solvent. Examples of such solvents include biphenyl compounds. An example of biphenyls is 2-methylbiphenyl. The lithium-containing non-aqueous solution that contains a biphenyl compound can suppress overcharging of the battery.

The volume fraction of the aprotic polar solvent in the total solvent of the lithium-containing non-aqueous solution may be 50 vol % or more, 60 vol % or more, 70 vol % or more, or 80 vol % or more.

The method for drying and removing the solvent of the lithium-containing non-aqueous solution is not particularly limited. For example, a method may be used in which the silicon primary particles doped with Li ions and the lithium-containing non-aqueous solution are separated into solid and liquid phases, followed by drying.

As the method for solid-liquid separation, suction filtration may be employed.

As the drying method, vacuum drying may be employed. When vacuum drying is performed, the drying temperature may be 25° C. or more, 50° C. or more, or 60° C. or more, and may be 100° C. or less, 80° C. or less, or 60° C. or less. In this case, the drying time may be 0.5 hours or more, one hour or more, or 1.5 hours or more.

### Binder

The electrode active material composite particle of the present disclosure may further include a binder. The binder can bind the electrode active material primary particles together.

The binder is not particularly limited and may, for example, be selected from: butadiene rubber (BR)-based binders; isobutylene-isoprene rubber (IIR)-based binders; acrylate-butadiene rubber (ABR)-based binders; styrene-butadiene rubber (SBR)-based binders; polyvinylidene fluoride (PVdF)-based binders; polytetrafluoroethylene (PTFE)-based binders: polyimide (PI)-based binders; carboxymethyl cellulose (CMC)-based binders; polyacrylate salt-based binders; polyacrylate ester-based binders; and combinations thereof.

The content of the binder in the electrode active material composite particle is not particularly limited and may be set as appropriate in consideration of factors such as desired binding properties.

### Voids

The electrode active material composite particle of the present disclosure have multiple voids. These voids can mitigate the impact of expansion and contraction of silicon during battery charging and discharging.

The number of voids, porosity, and size of the voids in the electrode active material composite particle are not particularly limited and may be set as appropriate in consideration of factors such as the degree of silicon expansion and contraction.

### Electrode Mixture

The electrode mixture may contain the electrode active material composite particle of the present disclosure, and may further optionally contain a solid electrolyte, a conductive additive, and a binder.

In the present disclosure, the term “electrode mixture” refers to a composition that can form an electrode active material layer either as it is or by further including other components. In the present disclosure, the term “electrode mixture slurry” refers to a slurry that contains a dispersion medium in addition to the electrode mixture and that can be applied and dried to form an electrode active material layer.

In the present disclosure, the “electrode mixture” may be a cathode mixture or an anode mixture, and may particularly be an anode mixture.

The components that can constitute the electrode mixture will be described below.

### Electrode Active Material Composite Particle

The description above may be referred to regarding the electrode active material composite particle.

The content of the electrode active material composite particles in the electrode mixture is not particularly limited and may be set as appropriate in consideration of factors such as a desired battery capacity.

### Solid Electrolyte

Examples of the solid electrolyte include inorganic solid electrolytes such as sulfide solid electrolytes, oxide solid electrolytes, nitride solid electrolytes, and halide solid electrolytes, and organic polymer electrolytes such as polymer electrolytes. The solid electrolyte may particularly be a sulfide solid electrolyte.

For example, when the battery is a lithium-ion secondary battery, the solid electrolyte may have lithium-ion conducting properties.

Examples of sulfide solid electrolytes having lithium-ion conducting properties include solid electrolytes containing Li, X (where X is at least one selected from P, As, Sb, Si, Ge, Sn, B, Al, Ga, and In), and S. The sulfide solid electrolyte may further contain O or a halogen element, or both. Examples of halogen elements include F, Cl, Br, and I.

Examples of sulfide solid electrolytes include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, LizS-SiS₂—P₂S₅—LiI, Li₂S—B₂S₃, Li₂S—P₂S₅—ZₘSₙ (where m and n are positive numbers and Z is Ge, Zn, or Ga), Li₂S—GeS₂, Li₂S—SiS₂—Li₃PO₄, and Li₂S—SiS₂-LiₓMO_{y} (where x and y are positive numbers and M is P, Si, Ge, B, Al, Ga, or In).

Examples of oxide solid electrolytes having lithium-ion conducting properties include solid electrolytes containing Li, Y (where Y is at least one selected from Nb, B, Al, Si, P, Ti, Zr, Mo, W, and S), and O. Specific examples include: garnet solid electrolytes such as Li₂La₃Zr₂O₁₂, Li₇₋ₓLa₃(Zr₂₋ₓNbₓ)O₁₂ (0≤x≤2), and Li₅La₃Nb₂O₁₂; perovskite solid electrolytes such as (Li,La) TiO₃, (Li,La) NbO₃, and (Li,Sr) (Ta,Zr) O₃; NASICON solid electrolytes such as Li(Al,Ti) (PO₄)₃ and Li(Al,Ga) (PO₄)₃; Li—P—O-based solid electrolytes such as Li₃PO₄ and LIPON (a compound in which part of O in Li₃PO₄ is substituted with N); and Li—B—O-based solid electrolytes such as Li₃BO₃ and compounds in which part of O in Li₃BO₃ is substituted with C.

The content of the solid electrolyte in the electrode mixture is not particularly limited and may be set as appropriate in consideration of factors such as desired ion conducting properties.

### Conductive Additive

The conductive additive may be, for example, a carbon material, metal particles, or a combination thereof. The carbon material may, for example, be selected from: non-fibrous carbon materials such as acetylene black (AB) and Ketjenblack (KB); fibrous carbon materials such as vapor-grown carbon fibers (VGCFs), carbon nanotubes (CNTs), and carbon nanofibers (CNFs); and combinations thereof. The metal particles may be, for example, nickel, copper, iron, stainless steel, or a combination thereof.

The content of the conductive additive in the electrode mixture is not particularly limited and may be set as appropriate in consideration of factors such as desired electrical conductive properties.

### Binder

The binder may be, for example, selected from: rubber-based binders such as butadiene rubber, hydrogenated butadiene rubber, styrene-butadiene rubber (SBR), hydrogenated styrene-butadiene rubber, nitrile-butadiene rubber, hydrogenated nitrile-butadiene rubber, acrylate-butadiene rubber (ABR), and ethylene-propylene rubber; fluorine-based binders such as polyvinylidene fluoride (PVdF), polyvinylidene fluoride-polyhexafluoropropylene copolymer (PVdF-HFP), polytetrafluoroethylene, and fluororubber; thermoplastic polyolefin resins such as polyethylene, polypropylene, and polystyrene; imide resins such as polyimide and polyamide-imide; amide resins such as polyamide; acrylic resins such as polymethyl acrylate and polyethyl acrylate; methacrylic resins such as polymethyl methacrylate and polyethyl methacrylate; and combinations thereof.

The content of the binder in the electrode mixture is not particularly limited and may be set as appropriate in consideration of factors such as desired binding properties.

### Other Components

The electrode mixture may or may not further contain components other than those described above.

### Battery

The battery of the present disclosure includes an electrode active material layer, and the electrode active material layer contains the electrode active material composite particle of the present disclosure. The battery of the present disclosure may include an anode current collector layer, an anode active material layer, an electrolyte layer, a cathode active material layer, and a cathode current collector layer in this order. In particular, the anode active material layer may contain the electrode active material composite particle of the present disclosure.

The battery of the present disclosure may be a liquid battery or a solid-state battery, and may particularly be a solid-state battery. In the present disclosure, the term “solid-state battery” refers to a battery that includes at least a solid electrolyte as an electrolyte. Accordingly, the solid-state battery may include a combination of a solid electrolyte and a liquid electrolyte as the electrolyte. The solid-state battery may be an all-solid-state battery, that is, a battery that includes a solid electrolyte as the electrolyte.

The battery of the present disclosure may be a secondary battery, and may particularly be a lithium-ion secondary battery.

The battery of the present disclosure may be restrained by restraining members such as end plates from both sides in the stacking direction of the above layers. Examples of such restraint methods include those using bolt tightening torque, but are not limited thereto.

The components constituting the battery of the present disclosure will be described below. The following description exemplifies a case where the battery of the present disclosure is an all-solid-state battery and the electrode active material layer containing the electrode active material composite particle of the present disclosure is an anode active material layer.

### Anode Current Collector Layer

The anode current collector layer may be, for example, in the form of a foil, plate, mesh, punched metal, or foam. The anode current collector layer may be a metal foil or a metal mesh, or may be a carbon sheet, and may particularly be a metal foil. The anode current collector layer may be formed of, for example, a plurality of foils or sheets.

The metal constituting the anode current collector layer is not particularly limited, and may, for example, be at least one metal selected from copper, nickel, chromium, gold, platinum, silver, aluminum, iron, titanium, zinc, cobalt, and stainless steel. In particular, the anode current collector layer may contain at least one metal selected from copper, nickel, and stainless steel.

To adjust resistance or for other purposes, a coating layer may be formed on the surface of the anode current collector layer. The anode current collector layer may be formed by plating or depositing, by vapor deposition, any of the above-mentioned metals on a metal foil or a substrate. When the anode current collector layer is formed of a plurality of metal foils, a layer may optionally be provided between the foils.

The thickness of the anode current collector layer is not particularly limited, and may be, for example, 0.1 μm or more, or 1 μm or more, and may be 1 mm or less, or 100 μm or less.

### Anode Active Material Layer

The anode active material layer contains the electrode active material composite particle of the present disclosure. Reference can be made to the above description for details of the electrode active material composite particle of the present disclosure.

The anode active material layer may be formed as a layer of the electrode mixture containing the electrode active material composite particle of the present disclosure. Reference can be made to the above description for details of the electrode mixture.

The thickness of the anode active material layer is not particularly limited and may be, for example, 0.1 μm or more and 1000 μm or less.

### Solid Electrolyte Layer

The solid electrolyte layer contains solid electrolyte particles, and may optionally further contain a binder or the like.

Reference can be made to the above description for details of the solid electrolyte particles and binder.

The thickness of the solid electrolyte layer is not particularly limited, and may be, for example, 0.1 μm or more and 1000 μm or less.

### Cathode Active Material Layer

The cathode active material layer contains a cathode active material, and may optionally further contain a solid electrolyte, a conductive additive, a binder, or the like.

The cathode active material is not particularly limited, and examples include oxide active materials. Examples of oxide active materials that are used in lithium-ion batteries include LiCoO₂, LiMnO₂, Li₂NiMn₃O₈, LiVO₂, LiCrO₂, LiFePO₄, LiCoPO₄, LiNiO₂, LiNi_{1/3}Co_{1/3}Mn_{1/3}O₂. In addition, a coating layer containing a lithium-ion conductive oxide (for example, LiNbO₃) may be formed on the surface of these active materials.

The content of the cathode active material in the cathode active material layer is not particularly limited.

Reference can be made to the above description for details of the solid electrolyte, conductive additive, and binder.

The thickness of the cathode active material layer is not particularly limited, and may be, for example, 0.1 μm or more and 1000 μm or less.

### Cathode Current Collector Layer

The cathode current collector layer may be, for example, in the form of a foil, plate, mesh, punched metal, or foam. The cathode current collector layer may be a metal foil or a metal mesh, and may particularly be a metal foil. The cathode current collector layer may be formed of a plurality of foils.

The metal constituting the cathode current collector layer is not particularly limited, and may, for example, be at least one metal selected from copper, nickel, chromium, gold, platinum, silver, aluminum, iron, titanium, zinc, cobalt, and stainless steel. In particular, the cathode current collector layer may contain aluminum.

To adjust resistance or for other purposes, a coating layer may be formed on the surface of the cathode current collector layer. The cathode current collector layer may be formed by plating or depositing, by vapor deposition, any of the above-mentioned metals on a metal foil or a substrate. When the cathode current collector layer is formed of a plurality of metal foils, a layer may optionally be provided between the foils.

The thickness of the cathode current collector layer is not particularly limited, and may be, for example, 0.1 μm or more, or 1 μm or more, and may be 1 mm or less, or 100 μm or less.

### Other Configurations

The battery may be configured such that the above components are housed within an outer casing. Any known outer casing used for batteries may be employed. A plurality of batteries may be electrically connected in any manner or stacked in any manner to form a battery module. In this case, the battery module may be housed within a known battery case. The battery may further include other well-known components such as terminals. The battery may be, for example, in the form of a coin-type, laminate (pouch)-type, cylindrical, or prismatic battery.

The method for manufacturing the battery of the present disclosure is not particularly limited, and may include, for example, forming an anode active material layer containing the electrode active material composite particle of the present disclosure.

As a method for forming an anode active material layer containing the electrode active material composite particle of the present disclosure, a method may be employed in which the electrode active material composite particles and any other desired components are mixed to obtain an electrode mixture, and the obtained electrode mixture is subjected to dry or wet forming.

The method for manufacturing the battery of the present disclosure may further include forming an electrode stack by stacking an anode current collector layer, an anode active material layer, a solid electrolyte layer, a cathode active material layer, and a cathode current collector layer in this order.

Other components such as terminals may be attached to the electrode stack as needed. The electrode stack is housed in a battery case and sealed to obtain a battery.

### Example 1

### Preparation of Electrode Active Material Primary Particles

### Synthesis of Porous Silicon Particles

Silicon (Si) particles (Kojundo Chemical Laboratory Co., Ltd., particle size 5 μm) and metallic lithium (Li) (Honjo Metal Co., Ltd.) were mixed in an agate mortar under an argon atmosphere to obtain a lithium-silicon (LiSi) precursor. In a glass reactor under an argon atmosphere, 1.0 g of the LiSi precursor and 200 mL of 1,3,5-trimethylbenzene (NACALAI TESQUE, INC.) as a dispersion solvent were mixed using an ultrasonic homogenizer (UH-50, manufactured by SMT Co., Ltd.) to prepare a mixed solution. The mixed solution was cooled to 0° C., and 200 mL of ethanol (NACALAI TESQUE, INC.) was added dropwise as a solvent for Li extraction. The resulting solution was allowed to react for two hours to obtain a reaction solution. Next, 100 mL of acetic acid (NACALAI TESQUE, INC.) was added dropwise to the reaction solution, and the resulting solution was allowed to react for one hour. The solution was then subjected to suction filtration to separate the solid reaction product from the liquid. The solid reaction product was vacuum-dried at 120° C. for two hours to obtain porous silicon particles.

Doping of Silicon with Lithium Ions

Li ions were doped into the porous silicon particles in the liquid phase as follows. Specifically, in a glass reactor under an argon atmosphere, 200 mL of 2-methyltetrahydrofuran (Tokyo Chemical Industry Co., Ltd.), 50 mL of 2-methylbiphenyl (Tokyo Chemical Industry Co., Ltd.), and 1 g of metallic Li (Honjo Metal Co., Ltd.) were mixed to prepare a lithium-containing non-aqueous solution. Then, 1 g of the porous silicon particles was added to the obtained lithium-containing non-aqueous solution, and the resulting solution was stirred for 40 hours. Subsequently, the solid product was separated from the lithium-containing non-aqueous solution by suction filtration. The solid product was then vacuum-dried at 60° C. for two hours. Electrode active material primary particles that were porous and contained an LiSi alloy were thus obtained as Example 1.

The d50 particle diameter of the obtained electrode active material primary particles was 1 μm. The d50 particle size was measured using a laser diffraction/scattering particle size distribution analyzer (Partica LA-960 V2, manufactured by HORIBA, Ltd.). Pure water was used as the dispersion medium, and the refractive index was set to 3.5.

### Preparation of Electrode Active Material Composite Particles

A solution in which styrene-butadiene rubber was dissolved or dispersed as a binder in an organic solvent serving as a dispersion medium was mixed with the electrode active material primary particles to prepare a slurry. The organic solvent in the slurry was removed by spray drying to produce electrode active material composite particles as secondary particles.

### Preparation of Anode Active Material Layer

An organic solvent was mixed with the obtained electrode active material composite particles, a binder, a conductive additive, and a solid electrolyte to prepare a mixed solution. The mixed solution was kneaded using an ultrasonic homogenizer to obtain an anode mixture slurry. The obtained anode mixture slurry was coated onto a copper foil serving as an anode current collector layer, and the organic solvent was removed by drying to form an anode active material layer. An anode laminate in which the anode current collector layer and the anode active material layer are laminated together was thus obtained. The obtained anode laminate was cut into strip-shaped pieces.

### Preparation of Solid Electrolyte Layer

A binder and a solid electrolyte were added to an organic solvent to prepare a mixed solution. This mixed solution was kneaded using an ultrasonic homogenizer to obtain a solid electrolyte composite slurry. The obtained solid electrolyte composite slurry was coated onto an aluminum (Al) foil serving as a release sheet, and the organic solvent was removed by drying to form a solid electrolyte layer. Three such solid electrolyte layers were prepared by the same procedure and cut into strip-shaped pieces.

### Preparation of Cathode Active Material Layer

A binder, a conductive additive, a solid electrolyte, and LiNi_{0.8}Co_{0.15}Mn_{0.05}O₂ as a cathode active material were added to an organic solvent to prepare a mixed solution. The mixed solution was kneaded using an ultrasonic homogenizer to obtain a cathode mixture slurry. The obtained cathode mixture slurry was coated onto an Al foil serving as a cathode current collector layer, and the organic solvent was removed by drying to form a cathode active material layer. A cathode laminate in which the cathode current collector layer and the cathode active material layer are laminated together was thus obtained. The obtained cathode laminate was cut into strip-shaped pieces.

### Fabrication of Battery

The anode laminate and a first solid electrolyte layer were stacked such that the anode active material layer faced the solid electrolyte layer, thereby forming a stack. This stack was roll-pressed at 25° C. under a pressure of 50 kN/cm to form a laminate. The Al foil serving as a release sheet was peeled off from the solid electrolyte layer to transfer the solid electrolyte layer onto the anode active material layer.

The cathode laminate and a second solid electrolyte layer were stacked such that the cathode active material layer faced the solid electrolyte layer, thereby forming a stack. This stack was roll-pressed at 165° C. under a pressure of 50 kN/cm to form a laminate. The Al foil serving as a release sheet was peeled off from the solid electrolyte layer to transfer the solid electrolyte layer onto the cathode active material layer.

The anode laminate with the transferred solid electrolyte layer and the cathode laminate with the transferred solid electrolyte layer were each punched out using punching dies with diameters of 13.00 mm and 11.28 mm, respectively.

A third solid electrolyte layer that had been punched out to a predetermined size was further transferred onto the first solid electrolyte layer laminated on the anode active material layer by using a uniaxial press. The anode laminate and the cathode laminate were stacked such that the solid electrolyte layer on the anode active material layer faced the solid electrolyte layer on the cathode active material layer, thereby obtaining an electrode body.

Current-collecting tabs were attached to the cathode active material layer and the anode active material layer. The electrode body was sealed in an Al laminate film using a vacuum laminating sealer and restrained under a pressure of 5 MPa to fabricate an all-solid-state battery.

The value of x in the compositional formula LiₓSi of the Li—Si alloy contained in the electrode active material composite particles of Example 1, as detected by the method described below, was 0.1. That is, LiₓSi was Li_{0.1}Si.

First, a sample was processed by the following method. After an all-solid-state battery was disassembled in an argon-atmosphere glove box (oxygen concentration: 10 ppm or less, dew point:−76° C. or less), the anode layer side was fixed to an atmosphere-isolated sample stage, and the sample was introduced into a processing and observation apparatus without exposure to the atmosphere. The all-solid-state battery was in the discharged state, that is, after CC-CV discharge to a lower-limit voltage of 0 V at 1/3 C to 1/100 C Cut. To protect the sample surface during focused ion beam (FIB) processing, the sample was coated with a carbon film in the processing and observation apparatus. Thereafter, by using the FIB micro-sampling method, a small specimen was extracted onto a copper mesh on a vacuum-transfer holder. The extracted specimen was then thinned by cryo-FIB processing at −100° C. to a thickness suitable for transmission electron microscopy (TEM) observation. The equipment used, together with the acceleration voltages and ion source, are as follows.

Equipment: Focused ion/electron beam processing and observation system nanoDUE'T (registered trademark) NB5000, manufactured by Hitachi High-Tech Corporation
Acceleration voltages: 40 kV, 30 kV, 10 kV, 5 kV
Ion source: gallium

The specimen was then observed by the following method. The specimen was mounted on a double-tilt vacuum-transfer holder (648 Double Tilt Vacuum Transfer Holder, manufactured by Gatan, Inc.) inside the glove box, introduced into the transmission electron microscope (TEM) apparatus without exposure to the atmosphere, and observed by Cs-STEM-EELS. The equipment used, together with the acceleration voltage and beam diameter, are as follows.

TEM apparatus: JEM-ARM200F, spherical-aberration-corrected scanning transmission electron microscope, manufactured by JEOL Ltd.
EDX analyzer: JED-2300T SDD, manufactured by JEOL Ltd.
EELS analyzer: GIF Quantum-ER, manufactured by Gatan, Inc.
Acceleration voltage: 200 kV
Beam diameter: approximately φ0.1 nm

### Evaluation

### Measurement of Increase in Constraining Pressure

The increase in constraining pressure when the obtained all-solid-state battery was charged from an uncharged state to 4.05 V was measured using a load cell. The results are shown in Table 1. The values shown in Table 1 are relative values in which the value of Comparative Example 1, described later, is taken as 100. The increase in constraining pressure represents the amount of expansion of the electrode active material composite particles.

### Example 2

Except that the mass ratio between the porous silicon particles and the lithium-containing non-aqueous solution during doping of silicon with Li ions was changed to obtain electrode active material primary particles containing an Li—Si alloy having the compositional formula Li_{0.3}Si, electrode active-material composite particles and an all-solid-state battery were produced and evaluated in the same manner as in Example 1. The results are shown in Table 1. The d50 particle size of the electrode active material primary particles in Example 2, as measured by the same method as in Example 1, was 1 μm.

### Comparative Example 1

Except that silicon was not doped with Li ions, that is, except that the above porous silicon particles were used as the electrode active material primary particles, electrode active material composite particles and an all-solid-state battery were produced and evaluated in the same manner as in Example 1. The results are shown in Table 1. The d50 particle size of the electrode active material primary particles in Comparative Example 1, as measured by the same method as in Example 1, was 1 μm.

TABLE 1

| | | | Increase in |
|---|---|---|---|
| | | | constraining |
| | Electrode active | | pressure |
| | material particles | x in LiₓSi | (—) |
| Comparative Example 1 | Composite particles | 0 | 100 |
| Example 1 | Composite particles | 0.1 | 95 |
| Example 2 | Composite particles | 0.3 | 92 |

As shown in Table 1, the batteries of the Examples including the electrode active material composite particle of the present disclosure exhibited smaller increases in constraining pressure than the battery of the Comparative Example.

### Reference Examples 1, 2 and Comparative Reference Example 1

Except that the electrode active material composite particles were not prepared and, instead, the electrode active material primary particles obtained in Examples 1, 2 and Comparative Example 1 were used, all-solid-state batteries were fabricated and evaluated in the same manner as in the respective Examples described above. The results are shown in Table 2. The values of increase in constraining pressure shown in Table 2 are relative values in which the value of Comparative Reference Example 1 is taken as 100.

TABLE 2

| | | | Increase in |
|---|---|---|---|
| | | | constraining |
| | Electrode active | | pressure |
| | material particles | x in LiₓSi | (—) |
| Comparative | Primary particles | 0 | 100 |
| Reference Example 1 | | | |
| Reference Example 1 | Primary particles | 0.1 | 99 |
| Reference Example 2 | Primary particles | 0.3 | 98 |

As shown in Tables 1 and 2, the batteries of the Examples that include composite particles having multiple voids around the primary particles exhibited greater suppression of the increase in constraining pressure than the batteries of the Reference Examples.

These results support the above-described mechanism in which, in the electrode active material composite particle of the present disclosure, the easily deformable electrode active material primary particles enable effective utilization of the voids within the composite particles.

What is claimed is:

1. An electrode active material composite particle comprising a plurality of electrode active material primary particles,
wherein the electrode active material primary particles include a lithium-silicon alloy in a discharged state.

2. The electrode active material composite particle according to claim 1, wherein the lithium-silicon alloy is represented by a compositional formula LiₓSi, where x is 0.1 or more as detected by Cs-STEM-EELS analysis.

3. The electrode active material composite particle according to claim 2, wherein x is from 0.1 to 0.5.

4. The electrode active material composite particle according to claim 1, wherein the electrode active material primary particles are porous.

5. A battery comprising an electrode active material layer,
wherein the electrode active material layer contains the electrode active material composite particle according to claim 1.
